(19) United States
(12) Patent Application Publication
(10) Pub. No.: US 2008/0267855 A1
(43) Pub. Date: Oct. 30, 2008

(54) PROCESS FOR THE PRODUCTION OF METAL FLUORIDE MATERIALS WITH SUBMICRON STRUCTURES

(76) Inventors: F.C. Greer, Coppell, TX (US); Ronald L. Elsenbaumer, Arlington, TX (US); David P. Owen, Dallas, TX (US)

Correspondence Address: FULBRIGHT & JAWORSKI L.L.P, 2200 ROSS AVENUE, SUITE 2800, DALLAS, TX, 75201-2784, US

(21) Appl. No.: 12/038,438

(22) Filed: Feb. 27, 2008

Related U.S. Application Data
(63) Continuation-in-part of application No. 10/662,992, filed on Sep. 15, 2003.

(51) Int. Cl. C01B 7/19

(52) U.S. Cl. 423/483

(57) ABSTRACT

A process for the production of metal fluorides comprising maintaining a low concentration of the by-products of the reaction between a non-fluorinated metal compound and hydrofluoric acid, so as to produce, by this reaction, sub-micron particle sizes of metal fluoride of high purity.

### CROSS-REFERENCE TO RELATED APPLICATIONS

This is a continuation-in-part of application Ser. No. 10/662,992, entitled PROCESS FOR THE PRODUCTION OF METAL FLUORIDE MATERIALS, filed Sep. 15, 2003, the disclosure of which is hereby incorporated herein by reference.

### TECHNICAL FIELD

The present invention relates to the manufacture of metal fluorides.

### BACKGROUND

Metal fluorides are employed in a large number of industrial applications, including but not necessarily limited to the following applications:
(1) Production of porcelain and ceramic materials;
(2) Production of materials useful in dyeing operations, such as mordants;
(3) Production of specialty glass formulations, particularly useful for optical transmission conductors;
(4) Production of antiseptics and germicides;
(5) Production of etching agents, particularly useful in the preparation of printed circuits;
(6) Production of thermal decomposition coatings as well as other coating applications such as thin film optical coatings;
(7) Production of fluoridating agents; and
(8) Production of catalyst materials for a wide range of applications.

It is known in the chemical arts that metal fluorides may be produced by reacting a metal or a non-fluorinated metal compound with hydrofluoric acid. When the non-fluorinated metal compound is a metal chloride (salt), the reactions are basically as follows:
MCI+HF→MF+HCl⇑
MCI₂+2HF→MF₂+2HCl⇑
MCI₃+3HF→MF₃+3HCl⇑
MCI₄+4HF→MF₄+4HCl⇑
MCIₙ+nHF→MFₙ+nHCl⇑

Though the above reactions for making metal fluorides are known in the art, improvements, especially in the chemical arts, are always desired. For example, when metal fluoride is used as a catalyst, the metal fluoride's effectiveness is enhanced if it has a high surface area (small particle sizes) and is of high purity. There exists a need, therefore, to produce metal fluoride with small particle sizes and high purity by a chemical reaction process.

### SUMMARY OF THE INVENTION

The present invention is directed to maintaining a low concentration of the by-products of the reaction between a non-fluorinated metal compound and hydrofluoric acid, so as to produce, by this reaction, sub-micron particle sizes of metal fluoride of high purity, high surface area and high chemical reactivity. Specifically, particular process conditions are applied to the reaction between the non-fluorinated metal compound and hydrofluoric acid to keep the concentration of the reaction by-products low.

In embodiments of the invention, the particular techniques are employed to maintain the concentration of the hydrogen halide by-product formed from the reaction between the non-fluorinated metal compound and hydrofluoric acid, below a certain level. Those techniques are:
(a) Gradually adding the non-fluorinated metal compound to excess anhydrous hydrofluoric acid in small portions at a time so that the mole ratio of metal halide to hydrofluoric acid is always very low;
(b) Maintaining the temperature of the reaction mixture in a specific range;
(c) Purging the reaction by-products; and
(d) Agitating the reaction mixture to quickly release by-products of the reaction.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying FIGURE and tables. It is to be expressly understood, however, that each of the FIGURE and tables is provided for the purpose of illustration and description only and is not intended as a definition of the limits of the present invention.

### BRIEF DESCRIPTION OF THE DRAWING

FIG. 1 is a flow diagram showing the processes involved in one embodiment of the invention.

### DETAILED DESCRIPTION

The reaction of a non-fluorinated metal compound with hydrofluoric acid to produce metal fluoride in the art generally involves adding liquid anhydrous hydrofluoric acid to a non-fluorinated metal halide in solid form. It should be noted that the reactants-non-fluorinated metal compound and hydrofluoric acid-are preferably anhydrous but the invention disclosed herein may also use reactants that are not anhydrous. The reaction between non-fluorinated metal compound with hydrofluoric acid also produces hydrogen halide gas as a by-product. An important principle of this invention is to maintain the amount of this hydrogen halide as low as possible at the reaction site.

In this disclosure, the amount of a substance, such as hydrogen halide, is expressed in moles and a mole ratio is simply the number of moles of one substance in relation to another in existence in a reaction zone such as a reaction vessel. The “reactants mole ratio” is defined as the mole ratio of one reactant to another in the reaction zone. Particular embodiments of the current invention use the gradual addition of non-fluorinated metal halide to excess anhydrous hydrofluoric acid to cause the mole ratio of non-fluorinated metal halide to anhydrous hydrofluoric acid to be low. In turn, the low mole ratios of non-fluorinated metal halide to anhydrous hydrofluoric acid ensures that the amount of hydrogen halide by-product, produced during the reaction at any one time, is small. While we wish not to be bound by any theory, we believe that this embodiment is a driving force for the production of sub-micron particle sized metal fluoride products of high purity. In one embodiment, the mole ratio is 1 mole metal halide to 10 moles of anhydrous hydrofluoric acid. In another embodiment, the mole ratio is 1 mole metal halide to 20 moles of anhydrous hydrofluoric acid. In a preferred embodiment, the mole ratio is 1 mole metal halide to 30 moles of anhydrous hydrofluoric acid. Apart from achieving a mole ratio in a particular range, when non-fluorinated metal halide is added in portions over time, the periods during which no addition is being made is an opportune time for the hydrogen halide by-product to be purged from the reaction vessel before the next addition of non-fluorinated metal halide and thereby before the next set of reactions.

It is highly desirable to maintain a low concentration of hydrogen halide by-product throughout the duration of the reaction. In particular, it is preferred that the mole ratio of HF to HX by-product (X-CL, Br, or I) be at least about 3:1, and more preferred be about 10: 1, and most preferred be at least about 30:1. Maintaining a suitable excess of HF to HX during the entire course of the reaction can be achieved by any or combination of choosing the total amount of HF to use at the start of the reaction, application of heat, stirring, agitation, gas purging, and the like to dilute and/or drive off the HX from the HF, or by constant dilution of the reaction mixture with the addition of more HF as the reaction proceeds.

Maintaining the mole ratio by the gradual addition of non-fluorinated metal halide to anhydrous hydrofluoric acid also affects the degree to which the reaction goes to completion and thus the formation of a relatively pure end-product. For each gram-mole of non-fluorinated metal compound introduced into the reaction vessel containing the anhydrous hydrofluoric acid, the reaction takes place in an instant and the resultant product, metal fluoride, precipitates and gravitates to the bottom of the reaction vessel. In this process, only a relatively small fraction of the anhydrous hydrofluoric acid will be consumed. Therefore, when the next portion of the non-fluorinated metal halide is introduced into the reaction vessel, it will encounter approximately the same weight and mole ratio of anhydrous hydrofluoric acid to non-fluorinated metal halide as did the initial portion of non-fluorinated metal halide. For example, considering the reaction of ferric trichloride with anhydrous hydrofluoric acid, if the process is commenced with an initial weight ratio of 30 to 1, anhydrous hydrofluoric acid to ferric trichloride, the last of ten portions of ferric trichloride shall encounter a weight ratio of no less than 26 to 1.

The chemical reaction that takes place when ferric trichloride is combined with anhydrous hydrofluoric acid is set forth below, wherein the stoichiometric combining weight of each chemical in the reaction is cited below each such chemical, as follows:

FeCl₃+3HD→FeF₃+3HCl⇑

162.2031 60.0189 112.8402 109.3818

Presupposing one gram-mole or 162.2031 grams of ferric trichloride were to be combined with a quantity of anhydrous hydrofluoric acid in a weight ratio of thirty (30) parts anhydrous hydrofluoric acid to one (1) part ferric trichloride, the first aliquot (portion) of one gram-mole or 162.2031 grams of ferric trichloride would be introduced into 4,866.093 grams of anhydrous hydrofluoric acid (30 to 1 weight ratio). The reaction would result in the consumption of 60.0189 grams of anhydrous hydrofluoric acid leaving 4806.0741 grams of anhydrous hydrofluoric acid unreacted.

The second aliquot of one-gram mole or 162.2031 grams of ferric trichloride would be introduced into the remaining 4,806.0741 grams of anhydrous hydrofluoric acid to cause a reaction and the consumption of an additional 60.0189 grams of anhydrous hydrofluoric acid, leaving 4746.0552 grams of anhydrous hydrofluoric acid unreacted. The combining weight ratio with the addition of the second aliquot would be 29.63 to 1, anhydrous hydrofluoric acid to ferric trichloride, prior to the reaction. The addition of a third aliquot of a gram-mole of ferric trichloride would result in a weight ratio of 29.26 to 1 immediately on introduction of the third aliquot.

It should be noted that for each gram-mole or 162.2031 grams of ferric trichloride introduced in the reaction zone and reacted with AHF, 3 moles or 109.3818 grams of HCl is produced. Thus, immediately after the first aliquot of ferric trichloride has completely reacted with AHF and prior to the introduction of the second aliquot of ferric trichloride, 3 moles of HCl would be in the reaction zone if there is no extraction of HCl. On introduction of the second aliquot of ferric trichloride, when the weight ratio of AHF to FeCl₃ is 29.63 to 1, the mole ratio of AHF to HCl is 80.08 to 1. When the second aliquot of FeCl₃ has reacted with AHF, 3 additional moles of HCL would have been produced making a total of 6 moles of HCl formed since the addition of the first aliquot of FeCl₃. Accordingly, on introduction of the third aliquot of FeCl₃ when the weight ratio of AHF to FeCl₃ is 29.26 to 1, the AHF to HCL mole ratio is 39.54 to 1.

The combining ratios for the first ten portions of one gram mole each or 162.2031 grams of ferric trichloride (“FeCl₃”) introduced into the initial quantity (4,866.093 grams) of anhydrous hydrofluoric acid (“AHF”) at the beginning of each aliquot addition of ferric chloride and the corresponding ratios of AHF to HCL are as follows:

| | | Weight | | | |
|---|---|---|---|---|---|
| | | Ratio of | Mole Ratio | | Mole Ratio |
| | | AHF to | of AHF to | Moles of | of AHF to |
| Amount of | | FeCl3 | FeCl3 | HCL | HCL |
| AHF prior to | Amount of | immediately | immediately | immediately | immediately |
| addition of | FeCl3 added in | as Aliquot | as Aliquot | as Aliquot | as Aliquot |
| Aliquot of | each Aliquot | of FeCl3 is | of FeCl3 is | of FeCl3 is | of FeCl3 is |
| FeCl3 (grams) | (grams) | added | added | added | added |
| 4866.093 | 0 | 30.00 to 0 | 243.23 to 0 | 0 | 243.23 to 0 |
| 4866.093 | 162.2 | 30.00 to 1 | 243.23 to 1 | 0 | 243.23 to 0 |
| 4806.0741 | 162.2 | 29.63 to 1 | 240.23 to 1 | 3 | 80.08 to 1 |
| 4746.0552 | 162.2 | 29.26 to 1 | 237.23 to 1 | 6 | 39.54 to 1 |
| 4686.0363 | 162.2 | 28.89 to 1 | 234.23 to 1 | 9 | 26.03 to 1 |
| 4626.0174 | 162.2 | 28.52 to 1 | 231.23 to 1 | 12 | 19.27 to 1 |
| 4565.9985 | 162.2 | 28.15 to 1 | 228.23 to 1 | 15 | 15.22 to 1 |
| 4505.9796 | 162.2 | 27.78 to 1 | 225.23 to 1 | 18 | 12.51 to 1 |
| 4445.9607 | 162.2 | 27.41 to 1 | 222.23 to 1 | 21 | 10.58 to 1 |
| 4385.9418 | 162.2 | 27.04 to 1 | 219.23 to 1 | 24 | 9.13 to 1 |
| 4325.9229 | 162.2 | 26.67 to 1 | 216.23 to 1 | 27 | 8.01 to 1 |

It must be noted that when the tenth aliquot of FeCl₃ is added to AHF, without any extraction of HCL from the reaction zone, the mole ratio of AHF to HCL is 8.01 to 1.

The gradual addition of non-fluorinated metal compound to excess anhydrous hydrofluoric acid is an important change from the present state of the art and results in much faster reactions, more complete reactions, more nearly pure resultant product, and significantly better quality control. Therefore, irrespective of the mole ratio of anhydrous hydrofluoric acid to ferric trichloride employed in the reaction, only the stoichiometric combining weights of the reactants should be consumed in the reaction. The surplus hydrofluoric acid may be recovered and used again.

Maintaining the temperature of the reaction mixture in a sufficiently high range helps to produce smaller particle sizes of the resultant metal fluoride product because a sufficiently high temperature helps to release the hydrogen halide by-product from solution in the hydrofluoric acid. In one embodiment, therefore, the reaction temperature should be kept between 5 and 19° C. In another embodiment, the reaction temperature should be kept between 10 and 19° C. In a preferred embodiment, the reaction temperature should be kept between 10 and 15° C.

To maintain the desired reaction temperature, heating or cooling is applied depending on whether the reaction between the particular non-fluorinated metal halide and hydrofluoric acid is endothermic or exothermic. Where the reactions are endothermic, it has been observed that the higher the temperature at the time of the reaction and the greater the rate of heat delivery to the reactants, the smaller the resultant metal fluoride particles. Thus, heat is provided for the endothermic reactions to ensure smaller metal fluoride particles. Where the reaction between the non-fluorinated metal halide and the anhydrous hydrofluoric acid is exothermic, the reaction would need to give up heat to its environment in order to go to completion. For exothermic reactions, therefore, the process is cooled to maintain the desired temperature.

Purging reaction by-products such as the hydrogen halide produced by the reaction of non-fluorinated metal compound and anhydrous hydrofluoric acid helps to maintain the hydrogen halide concentration in the reaction vessel below the desired concentration. The purging can be done by means of equipment such as a compressor.

Agitating the reaction mixture helps the release of the hydrogen halide by-product from solution in the hydrofluoric acid and thereby keeping the hydrogen halide concentration below the desired concentration. Agitation can be achieved by various means including but not limited to, rotation agitation of the reaction vessel, high energy ultrasound, magnetic stirring, conventional stirring, and the like.

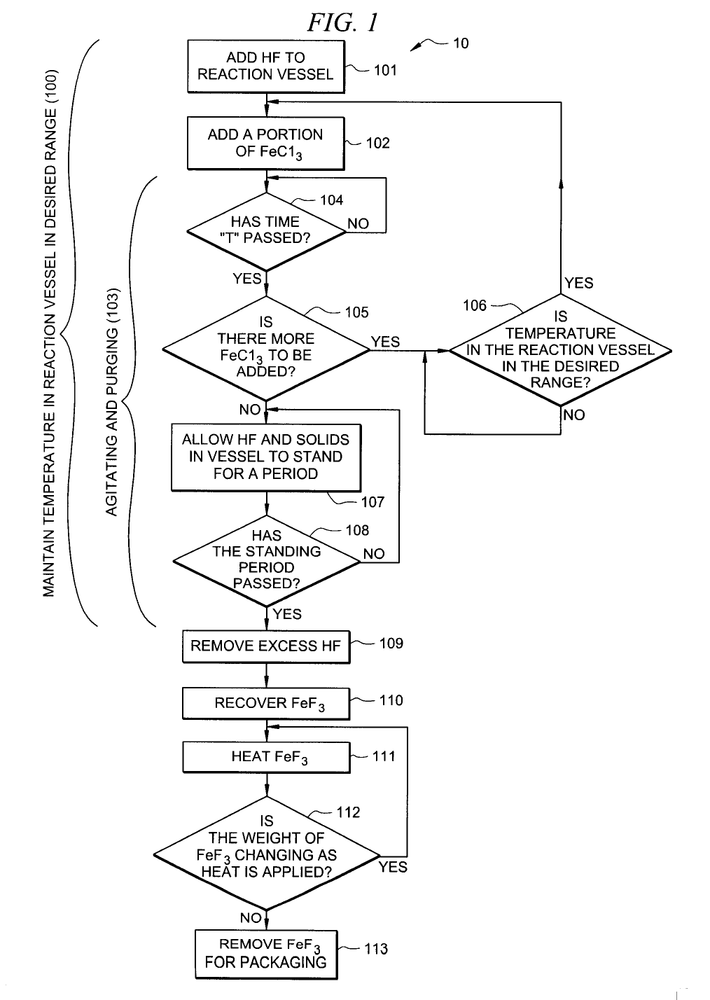

FIG. 1 is a flow chart 10 showing processes in accordance with an embodiment of the invention. The process for the production of metal fluoride begins with bringing a reaction vessel to a predetermined temperature and maintaining this temperature throughout the chemical reaction process as depicted by item 100. Hydrofluoric acid (HF) is added to the reaction vessel in process 101. Subsequently, in process 102 a pre-determined portion of the total amount of FeCl₃ is added to the HF. At this point, agitation of the contents of the reaction vessel and purging of reaction by-products from the vessel may be started and proceeds until HF has been removed from the reaction vessel as indicated by item 103.

The process then requires a period of time (t) to pass before the next portion of FeCl₃ is added. Period “t” in combination with the predetermined portion of FeCl₃ is determined so as to ensure the concentration of the reaction by product, hydrochloric acid (HCL) of the reaction between the FeCl₃ and HF is maintained in an acceptable range. Thus, at process 104, it is determined whether time “t” has passed. If time “t” has not passed then the process waits before any other addition of FeCl₃ is made. If time “t” has passed then, in process 105, it is determined whether more FeCl₃ is left to be added to the HF. If more FeCl₃ is to be added, then process 106 checks whether the temperature in the reaction vessel is in the desired range. If the temperature is not in the desired range, the addition of more FeCl₃ is delayed until the temperature reaches the desired range. If the temperature in the reaction vessel is in the desired range, then process 102 adds another portion of FeCl₃. If there is no more FeCl₃ to be added, then the contents of the reaction vessel are allowed to stand for a pre-determined period in process 107. The temperature in the reaction vessel is maintained in the desired range during this period as shown by item 100. Similarly, agitation of the contents and purging of the reaction vessel continues during the standing period as shown by item 103. In process 108 it is determined if the standing period has passed.

When the standing period has passed, in process 109, excess HF is removed from the reaction vessel. Then, in process 110, the submicron particles of FeF₃ are recovered. Heat is then applied in process 111. As heat is being applied to the submicron FeF₃, process 112 determines whether the weight of submicron FeF₃ is changing. If the weight of the FeF₃ is changing then heating is continued. If not, the FeF₃ is removed for packaging in process 113.

### EXAMPLE

Described below is an example of one particular embodiment of the invention. This embodiment involves the production of ferric trifluoride by reacting anhydrous ferric tricholoride and anhydrous hydrofluoric acid.

A clean 150 liter (40 gallon) reaction pressure vessel, constructed of a material inert to hydrogen fluoride and designed with a working pressure rating of zero to 400 psia and working temperature rating of zero to 300° F. is optionally equipped with thermostatically controlled resistance heating equipment capable of being set at any temperature within the working temperature range and equipped with a stirring device, agitation device, or ultrasound agitation equipment complete with a settable controller. Furthermore, the reaction vessel is equipped with at least five working pressure and temperature rated gate valves designed to provide convenient introduction of the reactants and the withdrawal of the resultant reaction products, three on the top of the vessel and two on the bottom of the cone shaped base of the vessel, which terminates in a pressure lock chamber separated by the two bottom gate valves. In addition, the reaction vessel is equipped with an appropriately designed and constructed automatic regulating gas back-pressure valve, if needed, that permits the setting and maintenance of any constant pressure, between zero psia and 400 psia, within the vessel. The reaction vessel is also equipped with a plunger device which enables solid anhydrous ferric trichloride reactant to be introduced into the reaction vessel at all pressures up to the full working pressure of the vessel.

The vessel is first cleaned of all stray chemicals and materials which might otherwise contaminate the resultant product. The clean reaction vessel is next purged three successive times with pure nitrogen gas. Thereafter, the reaction vessel is blanketed with nitrogen gas. The back-pressure regulator on the reaction vessel, if needed, is set at the desired pressure.

The reaction vessel is then loaded with 40 kg (50 liters) of anhydrous hydrofluoric acid, which is pumped into the vessel. Note, nitrogen gas will escape as it is displaced by the anhydrous hydrofluoric acid being introduced into the vessel, in view of the fact that the back-pressure regulator will maintain a constant back pressure of desired value. The reaction vessel resistance heater and stirring or agitation devices are then engaged and the reaction vessel temperature is brought up to a thermostatically controlled temperature between 5-19° C.

Theoretically, at the basic stoichiometric combining ratios, as much as 150.4 kg of anhydrous ferric trichloride could be added to the 40 kg of anhydrous hydrofluoric acid in the reaction vessel and the reaction could be expected to go to completion. However, previous observations have taught that high weight ratios of anhydrous hydrofluoric acid to ferric trichloride have quite reliably resulted in submicron size particles of a higher purity ferric trifluoride product.

In this embodiment of the invention, a weight ratio of anhydrous hydrofluoric acid to ferric trichloride of 30 to 1 is employed. Therefore, 1.33 kg of 99.9% pure (catalyst grade) anhydrous ferric trichloride is preheated to about 5-19° C. and then introduced into the reaction vessel using the plunger device. In view of the fact that it is an object of this invention that the ferric trichloride is to be introduced slowly and uniformly, not more than 133 grams are introduced with each cycle of the plunger device. Furthermore, between 5 and 60 minutes of reaction time is allowed between each successive addition of ferric trichloride depending on the reaction temperature and time needed to purge the by-product HCl.

The ferric trifluoride formed upon the reaction of the anhydrous ferric trichloride and the anhydrous hydrofluoric acid is immediately insoluble, and is denser than the anhydrous hydrofluoric acid. As a consequence, the ferric trifluoride gravitates to the base of the vessel and settles into the pressure lock chamber on the bottom, formed with the two lower gate valves. The solid resultant product collection process, as well as the reaction itself, can be aided to a great extent by ultrasound agitation on the vessel, or by mechanical stirring.

During the reaction, hydrochloric gas is evolved and insofar as the gas pressure in the reaction vessel exceeds the back pressure valve setting, the excess hydrogen chloride gas is automatically allowed to escape or extracted from the reaction vessel, perhaps along with some of the nitrogen gas used initially to charge and blanket the reaction vessel. The anhydrous hydrofluoric acid, on the other hand, should remain in the liquid phase at the reaction pressure and temperature conditions of 5-19° C. Following the addition period, the solid material is allowed to remain in contact with the anhydrous hydrofluoric acid for a period of approximately 1-3 days, while the reaction vessel is maintained at about 5-19° C. and is continued to be agitated by the appropriate device.

The excess hydrofluoric acid is then removed by evaporating it from the reaction vessel through the automatic regulating gas back pressure valve. This is accomplished by progressively reducing the set pressure on the automatic regulating gas back pressure valve while maintaining the elevated temperature in the range 5-19° C. on the reaction vessel, until all of the anhydrous hydrofluoric acid has been volatilized. The vapor phase anhydrous acid is then passed through a heat exchanger to reduce the temperature below the condensation temperature (19.8° C. or 67.6° F.) at standard atmospheric pressure and thereby recover the unused anhydrous hydrofluoric acid in the liquid phase. The resultant submicron ferric trifluoride product is removed from the gate valves on the bottom of the reaction vessel provided for such purpose.

Once the resultant ferric trifluoride product is collected, it is dried in an inert atmosphere at temperatures between about 80-150° C. Then the ferric trifluoride product is promptly packaged and sealed in such a manner so as to avoid hydration and/or any other forms of contamination of the ferric trifluoride.

Though the example above involves ferric trifluoride, similar results were obtained with TiF₃ and SNF₄ starting from TiCL₃ and SnCl₄, respectively. One skilled in the art would recognize that fluorides of Group VIII metals may be produced by the methods disclosed herein. Further, fluorides of the metals belonging to Groups IVB, VB, VIB, VIIB and IB transition metals, and Ga, In, Sn and Pb may be produced by the methods disclosed herein. Similarly, though metal chlorides are disclosed as reactants in the method, it must be noted that one skilled in the art would recognize that metal bromides and metal iodides may be used to carry out the method disclosed because chlorine, bromine and iodine are all halogens belonging to Group VIIA.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method for producing a metal fluoride with submicron particle sizes, high surface area, high purity, and high chemical reactivity, said method comprising:
introducing a quantity of hydrofluoric acid in a reaction zone; and
adding a quantity of non-fluorinated metal halide, a portion at a time over a period, to said hydrofluoric acid to cause a reaction between said non-fluorinated metal halide and said hydrofluoric acid, wherein said adding is at a rate so as to maintain in a particular range, a mole ratio in said reaction zone of a hydrogen halide by-product of said reaction to said hydrofluoric acid.

2. The method of claim 1 wherein said maintained ratio in said reaction zone is at least about 3 moles of hydrofluoric acid to 1 mole of hydrogen halide.

3. The method of claim 1 wherein said maintained ratio in said reaction zone is at least about 10 moles of hydrofluoric acid to 1 mole of hydrogen halide.

4. The method of claim 1 wherein said maintained ratio in said reaction zone is at least about 20 moles of hydrofluoric acid to 1 mole of hydrogen halide.

5. The method of claim 1 wherein said addition maintains a reactants mole ratio of 1 mole of said non-fluorinated metal halide to at least about 10 moles of said hydrofluoric acid in said reaction zone.

6. The method of claim 1 wherein said reactants mole ratio in said reaction zone is 1 mole of said metal halide to at least about 20 moles of said hydrofluoric acid.

7. The method of claim 1 wherein said reactant mole ratio in said reaction zone is 1 mole of said metal halide to at least about 30 moles of said hydrofluoric acid.

8. The method of claim 1 further comprising:
maintaining a temperature in said reaction zone in the range of about 0-19° C.

9. The method of claim 1 further comprising:
maintaining a temperature in said reaction zone in the range of about 5-19° C.

10. The method of claim 1 further comprising: maintaining a temperature in said reaction zone in the range of about 15-19° C.

11. The method of claim 1 further comprising:
agitating said mixture during said addition, said agitating aiding said maintenance of said mole ratio range.

12. The method of claim 1 further comprising:
evacuating said hydrogen halide from said vessel, said evacuation aiding said maintenance of said mole ratio range.

13. The method of claim 1 further comprising:
allowing the contents of said reaction vessel to stand for a period of about 1-3 days after said adding is completed and where said temperature in the range of about 0-19° C. is maintained for said standing period.

14. The method of claim 13 further comprising:
drying said metal fluoride compound by heating said metal fluoride to a temperature in the range of about between 80-150° C. for a period sufficient to allow said metal fluoride to reach a constant weight at or below atmospheric pressure.

15. The method of claim 1 wherein a metal of said metal halide is selected from the list of metals consisting of:
Gallium, Indium, Tin and Lead, Groups IVB, VB, VIB, VIIB, VII and IB.

16. The method of claim 1 wherein a metal of said metal halide is selected from the list consisting of:
Iron, Nickel, Cobalt, Chromium, Molybdenum, Titanium, Zirconium, Tin, and Zinc.

17. The method of claim 1 wherein a halogen of said metal halide is selected from the list consisting of:
Chlorine, Bromine and Iodine, or mixtures thereof.

18. The method of claim 1 wherein said non-fluorinated metal halide and said hydrofluoric acid are anhydrous.

19. The method of claim 1 wherein the addition period is at least 8 hours.

20. A method for producing a metal fluoride with submicron particle sizes, high surface area and high chemical reactivity, said method comprising:
introducing a quantity of hydrofluoric acid into a reaction zone; and
adding a quantity of non-fluorinated metal halide, a portion at a time over a period, to said hydrofluoric acid to cause a reaction between said non-fluorinated metal halide and said hydrofluoric acid; wherein said adding is at a rate so as to maintain the mole ratio of a hydrogen halide by-product to said hydrofluoric acid in a particular range; wherein a reactant mole ratio in said reaction vessel is 1 mole of said metal halide to at least about 3 moles of said hydrofluoric acid;
maintaining a temperature in said reaction vessel in the range of about 0-19° C.;
evacuating said hydrogen halide from said vessel, said evacuation aiding said maintaining of the mole ratio;
allowing the contents of said reaction vessel to stand for a period of about 1-3 days after said adding is completed and wherein said temperature in the range of about 0-19° C. is maintained for said standing period; and
drying said metal fluoride compound by heating said metal fluoride to a temperature in the range of about 80-150° C. for a period sufficient to allow said metal fluoride to reach a constant weight at or below atmospheric pressure.

21. The method of claim 20 wherein said maintained ratio is at least about 3 moles of hydrofluoric acid to 1 mole of hydrogen halide in the reaction zone.

22. The method of claim 20 wherein said maintained ratio is at least about 10 moles of hydrofluoric acid to 1 mole of hydrogen halide in the reaction zone.

23. The method of claim 20 wherein said maintained ratio is at least about 20 moles of hydrofluoric acid to 1 mole of hydrogen halide in the reaction zone.

24. A method for producing a ferric fluoride with submicron particle sizes, high surface area and high chemical reactivity, said method comprising:
introducing a quantity of hydrofluoric acid into a vessel; and
adding a quantity of ferric trichloride, a portion at a time over a period, to said hydrofluoric acid to cause a reaction between said ferric trichloride and said hydrofluoric acid; wherein said adding is at a rate so as to maintain the mole ratio of a hydrogen chloride by-product of said reaction to said hydrofluoric acid in a particular range; wherein a reactant mole ratio in said reaction vessel is 1 mole of said ferric trichloride to at least about 3 moles of said hydrofluoric acid;
maintaining a temperature in said reaction vessel in the range of about 0-19° C.;
evacuating said hydrogen chloride from said vessel, said evacuation aiding said maintaining of the mole ratio;
allowing the contents of said reaction vessel to stand for a period of about 1-3 days after said adding is completed and wherein said temperature in the range of about 0-19° C. is maintained for said standing period; and
drying said metal fluoride compound by heating said metal fluoride to a temperature in the range of about 80-150° C. for a period sufficient to allow said metal fluoride to reach a constant weight at or below atmospheric pressure.
